(19) United States
(12) Patent Application Publication
(10) Pub. No.: US 2013/0136980 A1
(43) Pub. Date: May 30, 2013

(54) ELECTROCHEMICAL CELL, ELECTRODE COMPOSITION THEREOF AND METHOD FOR MAKING SAME

(71) Applicant: Brandon Alan Bartling, Bethlehem, NY (US)

(72) Inventor: Brandon Alan Bartling, Bethlehem, NY (US)

(73) Assignee: GENERAL ELECTRIC COMPANY, SCHENECTADY, NY (US)

(21) Appl. No.: 13/307,555

(22) Filed: Nov. 30, 2011

(51) Int. Cl. H01M 4/64; H01M 4/38; H01M 4/42; H01M 4/44; H01M 10/02; H01M 10/04

(52) U.S. Cl. 429/188; 429/211; 29/623.1; 252/182.1

(57) ABSTRACT

A composition of the positive electrode comprises at least one electroactive metal, at least one iodide of at least one transition metal, a first alkali metal halide, and an electrolyte salt having a melting point of less than about 300° C. The at least one electroactive metal is selected from the group consisting of titanium, vanadium, niobium, nickel, cobalt, chromium, manganese, silver, antimony, cadmium, tin, lead, iron, and zinc. An electrochemical cell and a method for making an electrochemical cell are also presented.

### BACKGROUND OF THE DISCLOSURE

The invention relates generally to electrochemical cells, electrode composition of the electrochemical cells and methods for making the same. More particularly, this invention relates to rechargeable or secondary cells, positive electrode composition of the rechargeable cells and methods for making the same.

Rechargeable cells, also referred to as secondary cells, have been widely used in energy storage applications. Typically, due to high energy storage capability, high power density and long cycle life, the rechargeable cells, such as sodium metal halide cells are used in relatively larger-scale energy storage applications, for example, in electric vehicles.

In some designs of such rechargeable cells, solid electrolyte tubes are designed to accommodate positive electrodes. The negative electrodes are thus located outside of the solid electrolyte tubes to be in ionic communication with the positive electrodes through the solid electrolyte tubes during discharging and charging of the rechargeable cells. Relative to the negative electrodes, such as sodium, control of composition of the positive electrodes is more important to the performance of such rechargeable cells.

There have been attempts to improve the performance of the rechargeable cells by changing the composition of the positive electrodes. For example, additives, such as sodium salts are added into the composition of the positive electrodes. However, this may cause low working capacity, or in the case of sulfur, non-uniform distribution causes variability and degradation of the cell performance, which is disadvantageous to the performance of the rechargeable cells.

Therefore, there is a need for new and improved rechargeable cells, positive electrode composition thereof and methods for making the rechargeable cells.

### BRIEF DESCRIPTION OF THE DISCLOSURE

A positive electrode composition is provided in accordance with one embodiment of the invention. The composition of the positive electrode comprises at least one electroactive metal, at least one iodide of at least one transition metal, a first alkali metal halide, and an electrolyte salt having a melting point of less than about 300° C. The at least one electroactive metal is selected from the group consisting of titanium, vanadium, niobium, nickel, cobalt, chromium, manganese, silver, antimony, cadmium, tin, lead, iron, and zinc.

An electrochemical cell is provided in accordance with another embodiment of the invention. The electrochemical cell comprises a first chamber configured to receive a positive electrode, a second chamber configured to receive a negative electrode, an anode current collector configured to contact the negative electrode, and a cathodic current collector configured to contact the positive electrode. The electrochemical cell further comprises a solid electrolyte disposed between the first chamber and the second chamber. The second chamber is separated from and in ionic communication with the first chamber through the solid electrolyte. Wherein the positive electrode comprises at least one electroactive metal, at least one iodide of at least one transition metal, a first alkali metal halide, and an electrolyte salt having a melting point of less than about 300° C. The at least one electroactive metal is selected from the group consisting of titanium, vanadium, niobium, nickel, cobalt, chromium, manganese, silver, antimony, cadmium, tin, lead, iron, and zinc.

Embodiment of the invention further provides a method for making an electrochemical cell. The method comprises introducing a positive electrode into a first chamber defined between a solid electrolyte and a cell case of an electrochemical cell; introducing a negative electrode into a second chamber defined by the solid electrolyte of the electrochemical cell; and extending a cathodic current collector into the first chamber. The second chamber is separated from and in ionic communication with the first chamber. Wherein the positive electrode comprises at least one electroactive metal, at least one iodide of at least one transition metal, a first alkali metal halide, and an electrolyte salt having a melting point of less than about 300° C. The at least one electroactive metal is selected from the group consisting of titanium, vanadium, niobium, nickel, cobalt, chromium, manganese, silver, antimony, cadmium, tin, lead, iron, and zinc.

These and other advantages and features will be better understood from the following detailed description of preferred embodiments of the invention that is provided in connection with the accompanying drawings.

### BRIEF DESCRIPTION OF THE DRAWINGS

FIG. 1 is a schematic diagram of an electrochemical cell in accordance with one embodiment of the invention; and

FIGS. 2-3 are exemplary test result diagrams of the electrochemical cells employing iodide nickel additives and iodide sodium additives in accordance with various embodiments of the invention.

### DETAILED DESCRIPTION OF THE INVENTION

Preferred embodiments of the present disclosure will be described hereinbelow with reference to the accompanying drawings. In the following description, well-known functions or constructions are not described in detail to avoid obscuring the disclosure in unnecessary detail.

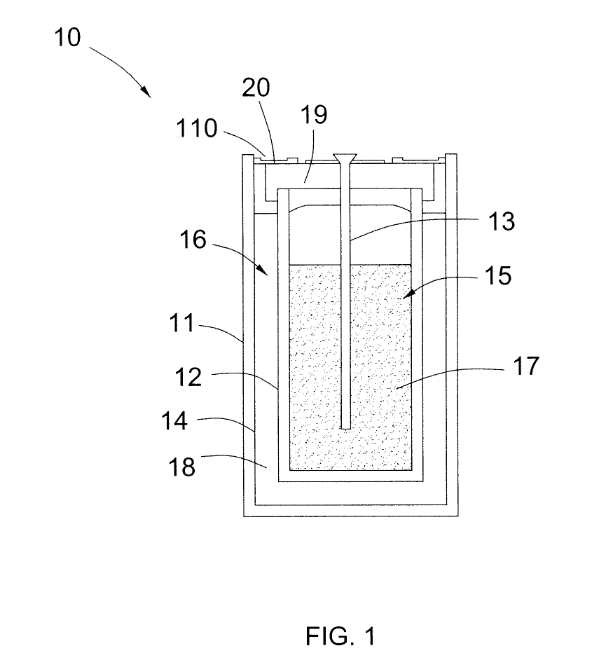

FIG. 1 illustrates a schematic diagram of an electrochemical cell 10 in accordance with one embodiment of the invention. In embodiments of the invention, the electrochemical cell 10 comprises a rechargeable cell used in energy storage applications. Although a single electrochemical cell 10 is illustrated, a plurality of the electrochemical cells 10 may be connected in parallel and/or in series to provide suitable voltages and battery capacities for relatively large-scale energy storage.

As illustrated in FIG. 1, the electrochemical cell 10 comprises a cell case 11, a solid separator 12, and a current collector 13. The cell case 11 is configured to receive or accommodate the solid separator 12. The solid separator 12 defines a first chamber 15 and is spaced away from an inner surface 14 of the cell case 11 for accommodation into the cell case 11 so that a second chamber 16 is defined therebetween.

In the illustrated example, the first chamber 15 is separated from and in ionic communication with the second chamber 16 through the solid separator 12. As used herein, the term “ionic communication” refers to traversal of ions between the first chamber 15 and the second chamber 16 through the solid separator 12.

The first chamber 15 is configured to receive cathodic materials acting as a positive electrode 17 and the second chamber 16 is configured to receive anodic materials acting as a negative electrode 18. As used herein, the cathodic materials are materials that supply electrons during a charging process of the electrochemical cell 10, and are present as part of a redox reaction. The anodic materials are configured to accept electrons during the charging process of the electrochemical cell 10, and are also present as part of the redox reaction.

Based on employment of different anodic and cathodic materials, different electrochemical cells may be formed. It should be noted that the electrochemical cell 10 is not limited to any specific electrochemical cells. In some non-limiting examples, the electrochemical cell 10 may comprise a metal-metal halide cell, such as a sodium metal halide cell including a sodium-nickel halide cell.

The cathodic materials of the positive electrode 17 have different functions at least including an electrode material and a support structure. The electrode materials are present in the positive electrode 17 as participating electrochemical reactants, both in their oxidized and reduced state, or at some state between full oxidation or reduction. The support structure usually does not undergo much change during any chemical reaction during the charge/discharge, but provide electron transport, and supports the electrode material as the electrode material undergoes chemical reaction and allows for a surface upon which solids may precipitate as needed.

In some embodiments, the composition of the positive electrode 17 comprises at least one electroactive metal, at least one first alkali metal halide, and an electrolyte salt. As used herein, the electroactive metal is a metal that oxidizes in molten sodium tetrachloroaluminate, resulting in a metal salt above the oxidation potential of aluminum, and below the oxidation potential of chloride.

Non-limiting examples of the electroactive metal may comprise at least one transition metal selected from the group consisting of titanium, vanadium, niobium, nickel, cobalt, chromium, manganese, silver, antimony, cadmium, tin, lead, iron, and zinc. In other examples, the electroactive metal may comprise at least one metal selected from antimony, cadmium, tin, lead, iron, and zinc. In addition, one or more of the electroactive metal may be present in a form of salts thereof, such as nitrates, sulfides, or halides thereof. In one non-limiting example, the electroactive metal comprises nickel.

In some applications, the amount of the electroactive metal in the composition of the positive electrode 17 may be in a range from about 10 volume percent to about 20 volume percent based on the volume of the positive electrode composition. In other applications, the amount of electroactive metal may be in a range from about 11 volume percent to about 19 volume percent. Additionally, the amount of electroactive metal may be is in a range from about 12 volume percent to about 18 volume percent.

In embodiments of the invention, the composition of the positive electrode 17 further comprises at least one iodide of the electroactive metal. In non-limiting examples, the at least one iodide of the electro active metal may comprise at least one iodide of at least one transition metal selected from the group consisting of titanium, vanadium, niobium, nickel, cobalt, chromium, manganese, silver, antimony, cadmium, tin, lead, iron, and zinc. In one example, the at least one iodide of the electroactive metal comprises nickel iodide.

In some examples, the amount of the iodide of the electroactive metal of the positive electrode 17 may be in a range from about 0.1 weight percent to about 1.7 weight percent, based on the weight of the composition of the positive electrode 17. In other examples, the amount of the iodide of the electroactive metal of the positive electrode 17 may be in a range from about 0.3 weight percent to about 1.4 weight percent. In non-limiting examples, the amount of the iodide of the electroactive metal of the positive electrode 17 may be in a range from about 0.12 weight percent to about 0.62 weight percent, for example, about 0.12 weight percent, about 0.31 weight percentage, or about 0.62 weight percent.

The first alkali metal halide comprises at least one alkali metal halide selected from sodium chloride, sodium bromide, sodium fluoride, potassium chloride, potassium bromide, potassium fluoride, lithium chloride, lithium bromide, lithium fluoride, and cesium chloride. In some applications, the amount of the first alkali metal halide in the positive electrode composition may be in a range from about 20 volume percent to about 50 volume percent, based on the volume of the positive electrode composition. In other applications, the amount of the first alkali metal halide in the positive electrode composition may be in a range from about 22 volume percent to about 48 volume percent.

The electrolyte salt comprises a reaction product of a second alkali metal halide and an aluminum halide. In non-limiting examples, the second alkali metal halide may comprise at least one alkali metal halide selected from sodium chloride, sodium bromide, sodium fluoride, potassium chloride, potassium bromide, potassium fluoride, lithium chloride, lithium bromide, lithium fluoride, and cesium chloride. In one example, the second alkali metal halide is sodium chloride and the metal halide of the electrolyte salt is aluminum chloride. Thus, the electrolyte salt comprises sodium tetrachloroaluminate (NaAlCl₄), which has a melting point of less than about 300° C. Alternatively, the electrolyte salt may comprise lithium chloroaluminate (LiAlCl₄), or potassium chloroaluminate (KAlCl₄)

For some arrangements, the amount of the electrolyte salt in the composition of the positive electrode 17 may be in a range of about 22 weight percent to about 35 weight percent, based on the total amount of the positive electrode composition. For other arrangements, the amount of the electrolyte salt may be in a range of about 25 weight percent to about 32 weight percent, based on the total amount of the positive electrode composition. Alternatively, the amount of the electrolyte salt may be in a range of about 28 weight percent to about 30 weight percent, based on the total amount of the positive electrode composition.

In some examples, the composition of the positive electrode 17 may further include aluminum, i.e., in a form other than an electrolyte salt or an aluminum halide. Usually, the aluminum would be in elemental form, e.g., aluminum metal flakes or particles. The aluminum may improve the porosity of the granules formed using the electroactive metal, iron, and alkali metal halide. For some arrangements, the amount of aluminum in the positive electrode composition may be in a range from about 0.2 volume percent to about 0.5 volume percent, based on the volume of the positive electrode composition. For other arrangements, the amount of aluminum in the positive electrode composition may be in a range from about 0.25 volume percent to about 0.45 volume percent.

In non-limiting examples, the composition of the positive electrode 17 may further comprise sulfur in the form of molecular sulfur or a sulfur-containing compound, such as iron sulfide. The amount of sulfur may be in the range from about 0.1 weight percent to about 3 weight percent, based on the total weight of the positive electrode composition. Alternatively, the composition of the positive electrode 17 may be free of sulfur because sulfur may be corrosive to diffusion bonds between ceramics and metals, which are often used in the electrochemical cells.

In certain applications, the composition of the positive electrode 17 may include other additives that may affect the performance of the electrochemical cell 10, for example, to increase ionic conductivity, to increase or decrease solubility of the charged cathodic species, or to improve wetting of the solid separator by a molten electrolyte. As used herein, additives mean those facilitate the ion transport mechanism, but do not themselves provide the mechanism, are distinguished from the electrolyte itself.

In some examples, the amount of the performance additives may be less than about 5 mole percent compared to the total combined moles of the first alkali metal halide, the electrolyte salt, and the electroactive metal in the positive electrode composition. Non-limiting examples of the performance additives may include alkali metal halide salt, such as sodium fluoride and sodium bromide.

For the illustrated arrangement in FIG. 1, the cell case 11 has a cylindrical cross section and defines an open upper end 110 so that the solid separator 12 is disposed within the cell case 11 through the open upper end thereof. Alternatively, the cell case 11 may have any other suitable cross sections, such as a rectangular cross section or a polygonal cross section. Suitable materials for the cell case 11 may include metal, ceramic, or a composite; or some combination thereof. Non-limiting examples of the metal may include nickel or steel. The ceramic may include a metal oxide.

Generally, the second chamber (anode compartment) 16 is empty in the ground state (uncharged state) of the electrochemical cell 10, and is filled with the anodic materials, such as the alkaline metal from reduced metal ions that move from the first chamber 15 to the second chamber 16 through the solid separator 12 during operation of the cell 10.

In non-limiting examples, the anodic materials of the negative electrode 18 may include alkaline metal, such as sodium, lithium and potassium, and is in a molten state during use. In one example, the negative electrode 18 comprises sodium. In some applications, the anodic materials of the negative electrode 18 may further comprise suitable additives, such as a metal oxygen scavenger. Suitable metal oxygen scavengers may include one or more of manganese, vanadium, zirconium, aluminum, or titanium. Other useful additives may include materials that increase wetting of the solid separator surface (not labeled) defining the second chamber 16 by the molten anodic materials.

As illustrated in FIG. 1, the solid separator 12 also defines an open upper end (not labeled) and may also have any suitable cross sections, such as a cylindrical cross section, a rectangular cross section or a polygonal cross section to provide a maximal surface area, for example, for alkali metal ion transportation during operation. In addition, the cell case 11 and/or the solid separator 12 also have suitable width-to-length ratios, respectively. In one non-limiting example, the cell case 11 and/or the solid separator 12 have a tube-like shape, respectively.

In embodiments of the invention, the solid separator 12 acts as a solid electrolyte to transport the ions, such as alkali metal ions between the first chamber (a cathode chamber) 15 and the second chamber (an anode chamber) 16. Suitable materials for the solid separators 12 may include an alkali-metal-beta′-alumina, alkali-metal-beta″-alumina, alkali-metal-beta′-gallate, or alkali-metal-beta″-gallate. In other examples, the solid separator 12 may include a beta-alumina, a beta″-alumina, a gamma alumina. In one example, the solid separator 12 includes a beta alumina. Alternatively, a portion of the solid separator 12 may include alpha alumina and another portion of the solid separator 12 may include beta alumina since the alpha alumina may be an ionic insulator.

Additionally, the solid separator 12 may be stabilized by the addition of small amounts of a dopant. The dopant may include one or more oxides selected from lithia, magnesia, zinc oxide, and yttria. These stabilizers may be used alone or in combination with themselves, or with other materials. In one example, the solid separator 12 comprises a beta alumina separator electrolyte (BASE), and may include one or more dopants.

For the illustrated arrangements, the current collector 13 extends into the first chamber 15 for electrical current collection and reduction of internal electric resistance of the electrochemical cell 10 during operation. Suitable materials for the current collector 13 may include platinum, palladium, gold, nickel, carbon, or titanium, and the current collector 13 may be a wire, paddle or mesh formed from.

The cell case 11 acts as another current collector for electrical current collection and reduction of the internal electric resistance of the electrochemical cell 10 during operation. In the illustrated example, since the first and second chambers 15, 16 are configured to receive the respective cathodic and anodic materials, the cell case 11 and the current collector 13 act as an anodic current collector and a cathodic current collector respectively during operation for electrical connection with a positive terminal and a negative terminal of an external circuit (not shown).

Additionally, a cover 20 of the electrochemical cell 10 is provided to be disposed on the upper end of the cell case 11 to provide suitable mechanical integrity to assemble and seal the elements, such as the solid electrolyte 12 and the sealing element 19 into the cell case 11. Suitable materials for the sealing element 19 may include glassy materials, a cermet or a combination thereof. Non-limiting examples of the glassy materials may include phosphates, silicates and borates. Non-limiting examples of the cermet may include alumina and a refractory metal. The refractory metals may include molybdenum, rhenium, tantalum, tungsten or other suitable metals. The cover 20 may comprise metals or alloys. In one example, the cover 20 comprises nickel.

Optionally, one or more shim structures (not shown) can be disposed within the volume of the cell case 11. The shim structures support the solid separator 12 within the volume of the cell case 11 to protect the solid separator 12 from vibrations caused by the motion of the cell 10 during use, and thus reduce or eliminate movement of the solid separator 12 relative to the cell case 11. In some embodiments, a shim structure may function as the anodic current collector as well as the cell case 11.

It should be noted that the arrangement in FIG. 1 is merely illustrative. For easy illustration, some elements of the electrochemical cell 10 are not illustrated, such as an insulator for electric insulation of the cell case 11 and the solid separator 12. Although the cell case 11 acts as the anodic current collector to electrically connect with the positive terminal of an external circuit, an additional electrically conductive element (not shown) may be disposed between and electrically connect the cell case 11 and an external circuit.

Thus, during operation, taking the sodium nickel cell as an example, in a charging state, nickel and sodium chloride in the first chamber 15 are converted into metal chloride and elemental sodium and the sodium is transferred electrochemically through the solid separator 12 to enter into the second chamber 16 for discharging.

In a discharging state, sodium in the second chamber 16 passes through the solid separator 12 electrochemically to enter into the first chamber 15 to react with the nickel chloride to produce sodium chloride and nickel so as to electrically neutralize the electrochemical cell 10, so that the chemical energy is converted to electrical energy and delivered to the external system. Other sodium metal chloride cells have similar operation processes as the sodium nickel chloride cells.

In current applications, additives, such as sodium iodide are added to change the composition of positive electrodes of electrochemical cells so as to improve the performance of the electrochemical cells. Descriptions of the positive electrodes including the sodium iodide additives can be found in a Non-provisional application Ser. No. 13/034,184, filed Feb. 24, 2011 (GE's Docket 247381-1), which is hereby incorporated by reference.

In embodiments of the invention, as mentioned above, the additives of at least one iodide of the electroactive metal, such as iodide nickel additives instead of the sodium iodide additives, are added into the composition of the positive electrode 17 to improve the performance of the electrochemical cell 10.

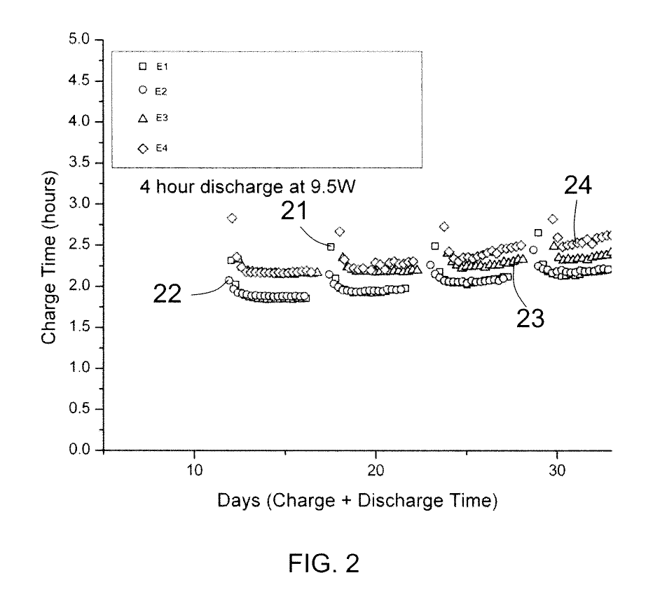

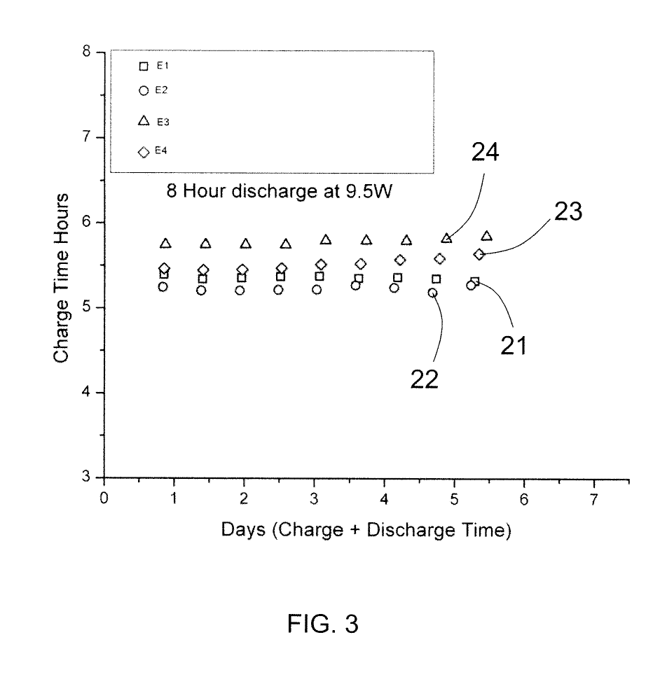

FIGS. 2-3 are exemplary test result diagrams of the charge time of the electrochemical cells employing respective iodide nickel additives and iodide sodium additives in accordance with various embodiments of the invention. In the exemplary tests, the percentages of the composition of the positive electrode in each of examples E1, E2, E3 and E4 are illustrated in Table-1. The “Others” of the positive electrode composition in each example includes nickel (Ni), aluminum (Al), sodium fluorine (NaF), iron sulfide (FeS), and iron (Fe). The percentages of the respective composition of the “Others” in the examples are similar and can be implemented by one skilled in the art.

Additionally, “E1” means an electrochemical cell including the iodide sodium additives. “E2” means an electrochemical cell including the iodide nickel additives, which has the same amount of the elemental iodide as the amount of the element iodide of the iodide sodium additives in a mol to mol basis. “E3” means an electrochemical cell including the iodide nickel additives, which has two and half times of amount of the elemental iodide to the amount of the element iodide in the iodide sodium additives in a mol to mol basis. “E3” means an electrochemical cell including the iodide nickel additives, which has five times of amount of the element iodide to the amount of the elemental iodide in the iodide sodium additives in a mol to mol basis.

TABLE 1

| Composition | E1 | E2 | E3 | E4 |
|---|---|---|---|---|
| NaI | 0.25 | 0.00 | 0.00 | 0.00 |
| NiI₂ | 0.00 | 0.12 | 0.31 | 0.62 |
| NaCl | 23.95 | 23.95 | 23.95 | 23.95 |
| NaAlC₄ | 30.15 | 30.15 | 30.15 | 30.15 |
| Others | 45.65 | 45.78 | 45.59 | 45.28 |

For each composition, three electrochemical cells were tested, so that the charge time results shown in FIGS. 2-3 are an average based on the tests of three electrochemical cells. For the exemplary test shown in FIG. 2, the testing conditions include 4 hours discharge at 9.5 W, which means in each cycle of discharging and charging, each of the electrochemical cells is charged after 4 hours discharging at 9.5 W. For the exemplary test shown in FIG. 3, the testing conditions include 8 hours discharge at 9.5 W, which means in each cycle of discharging and charging, each of the electrochemical cells is charged after 8 hours discharging at 9.5 W.

As illustrated in FIGS. 2-3, curves 21, 22, 23 and 24 represent the testing results of the charging time for E1, E2, E3, and E4, respectively. As can be seen from the tests in FIG. 2, during the operation time (discharge time and charge time, as illustrated in the X-axis), the charge time, as shown by the curve 22, is relatively stable and about two hours, and the charge time, as shown by the curves 23, 24 are also relatively stable and about 2.25 hours, which indicates the electrochemical cells including the iodide nickel have a relatively higher performance.

Compared to the electrochemical cells including the iodide sodium additives, a larger portion of the curves 21, 22 are overlapped, so that the electrochemical cells in the examples E1 and E2 have similar operating performance. Although the curves 23, 24 are located above the curve 21, 22, the differences of the charge time are smaller.

Similarly, as illustrated in FIG. 3, during the operation time (discharge time and charge time), the charge time, as shown by the curves 22-24, are relatively stable and located between five hours and six hours, which also indicates the electrochemical cells including the iodide nickel have a relatively higher performance.

Compared to the electrochemical cells including the iodide sodium additives, the curves 21, 22 are closed to each other, so that the electrochemical cells in the examples E1 and E2 have similar operating performance. Although the curves 23, 24 are located above the curve 21, 22, the differences of the charge time are also smaller. Thus, for the tests in FIGS. 2-3, the iodide nickel additives are added into the composition of the positive electrode 17 to replace the iodide sodium additives used in current applications.

In embodiments of the invention, the composition of the positive electrode 17 includes the at least one iodide of the at least one electroactive metal, such as the iodide nickel to improve the performance of the electrochemical cell 10. In addition, the iodide nickel additives may be used to replace the iodide sodium additives to increase the flexibility of the positive electrode composition.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A composition of a positive electrode, comprising:
at least one electroactive metal selected from the group consisting of titanium, vanadium, niobium, nickel, cobalt, chromium, manganese, silver, antimony, cadmium, tin, lead, iron, and zinc;
at least one iodide of at least one transition metal;
a first alkali metal halide; and
an electrolyte salt having a melting point of less than about 300° C.

2. The composition of the positive electrode of claim 1, wherein the at least one transition metal is selected from the group consisting of titanium, vanadium, niobium, nickel, cobalt, chromium, manganese, silver, antimony, cadmium, tin, lead, iron, and zinc.

3. The composition of the positive electrode of claim 2, wherein the at least one transition metal comprise nickel.

4. The composition of the positive electrode of claim 1, wherein an amount of the at least one iodide of the at least one transition metal is in a range from about 0.1 weight percent to about 1.7 weight percent based on a weight of the composition of the positive electrode.

5. The composition of the positive electrode of claim 1, wherein an amount of the at least one iodide of the at least one transition metal is in a range from about 0.3 weight percent to about 1.4 weight percent based on a weight of the composition of the positive electrode.

6. The composition of the positive electrode of claim 1, wherein an amount of the at least one iodide of the at least one transition metal is in a range from about 0.12 weight percent to about 0.62 weight percent based on a weight of the composition of the positive electrode.

7. The composition of the positive electrode of claim 1, wherein an amount of the at least one iodide of the at least one transition metal is about 0.12 weight percent based on a weight of the composition of the positive electrode.

8. The composition of the positive electrode of claim 1, wherein the first alkali metal halide comprises sodium chloride, and wherein the electrolyte salt comprises one of sodium chloroaluminate, lithium chloroaluminate, or potassium chloroaluminate.

9. The composition of the positive electrode of claim 1, further comprising aluminum, sodium fluorine, iron sulfide, and iron.

10. An electrochemical cell, comprising:
a first chamber configured to receive a positive electrode;
a second chamber configured to receive a negative electrode;
an anode current collector configured to contact the negative electrode;
a cathodic current collector configured to contact the positive electrode; and
a solid electrolyte disposed between the first chamber and the second chamber separated from and in ionic communication with the first chamber through the solid electrolyte;
wherein the positive electrode comprising:
at least one electroactive metal selected from the group consisting of titanium, vanadium, niobium, nickel, cobalt, chromium, manganese, silver, antimony, cadmium, tin, lead, iron, and zinc;
at least one iodide of at least one transition metal;
a first alkali metal halide; and
an electrolyte salt having a melting point of less than about 300° C.

11. The electrochemical cell of claim 10, wherein the at least one transition metal is selected from the group consisting of titanium, vanadium, niobium, nickel, cobalt, chromium, manganese, silver, antimony, cadmium, tin, lead, iron, and zinc.

12. The electrochemical cell of claim 10, wherein the at least one transition metal comprise nickel.

13. The electrochemical cell of claim 10, wherein an amount of the at least one iodide of the at least one transition metal is in a range from about 0.1 weight percent to about 1.7 weight percent based on a weight of the composition of the positive electrode.

14. The electrochemical cell of claim 10, wherein an amount of the at least one iodide of the at least one transition metal is in a range from about 0.3 weight percent to about 1.4 weight percent based on a weight of the composition of the positive electrode.

15. The electrochemical cell of claim 10, wherein an amount of the at least one iodide of the at least one transition metal is in a range from about 0.12 weight percent to about 0.62 weight percent based on a weight of the composition of the positive electrode.

16. The electrochemical cell of claim 10, wherein an amount of the at least one iodide of the at least one transition metal is about 0.12 weight percent based on a weight of the composition of the positive electrode.

17. The electrochemical cell of claim 10, wherein the positive electrode further comprising aluminum, sodium fluorine, iron sulfide, and iron.

18. A method for making an electrochemical cell, comprising:
introducing a positive electrode into a first chamber defined between a solid electrolyte and a cell case of an electrochemical cell;
introducing a negative electrode into a second chamber defined by the solid electrolyte of the electrochemical cell and separated from and in ionic communication with the first chamber; and
extending a cathodic current collector into the first chamber;
wherein the positive electrode comprising:
at least one electroactive metal selected from the group consisting of titanium, vanadium, niobium, nickel, cobalt, chromium, manganese, silver, antimony, cadmium, tin, lead, iron, and zinc;
at least one iodide of at least one transition metal;
a first alkali metal halide; and
an electrolyte salt having a melting point of less than about 300° C.

19. The method of claim 18, wherein the at least one electro active metal and the at least one transition metal comprise nickel.

20. The method of claim 18, wherein an amount of the at least one iodide of the at least one transition metal is in a range from about 0.1 weight percent to about 1.7 weight percent based on a weight of the composition of the positive electrode.

21. The method of claim 18, wherein an amount of the at least one iodide of the at least one transition metal is in a range from about 0.12 weight percent to about 0.62 weight percent based on a weight of the composition of the positive electrode.

22. The method of claim 18, wherein an amount of the at least one iodide of the at least one transition metal is about 0.12 weight percent of a weight of the composition of the positive electrode.

23. The method of claim 18, wherein the positive electrode further comprising aluminum, sodium fluorine, iron sulfide, and iron.
